(19) United States
(12) Patent Application Publication
(10) Pub. No.: US 2017/0123964 A1
(43) Pub. Date: May 4, 2017

(54) Finding Duplicates in Prior Runs of Static Analysis Tools

(71) Applicant: International Business Machines Corporation, Armonk, NY (US)

(72) Inventor: Michael T. Strosaker, Austin, TX (US)

(21) Appl. No.: 14/932,123

(22) Filed: Nov. 4, 2015

(51) Int. Cl. G06F 11/36

(52) U.S. Cl. CPC G06F 11/3692; G06F 11/3612

(57) ABSTRACT

An approach is provided in which a duplicate complaint detection system captures current source code partitions that each corresponds to current complaints included in a current static analysis report. The duplicate complaint detection system then computes similarity scores corresponding to the new complaints based upon aligning at least one of the current source code partitions to at least one prior source code partition corresponding to a prior complaint. The duplicate complaint detection system determines that one or more of the similarity scores are below a similarity threshold, which indicates that their corresponding current complaints are new complaints. In turn, the duplicate complaint detection system highlights the new complaints included in the current static analysis report.

### BACKGROUND

The present disclosure relates to identifying duplicate complaints between current runs and prior runs produced by static analysis tools. More particularly, the present disclosure relates to an approach of highlighting new complaints discovered in current static analysis tool runs in a continuous integration environment. Continuous integration (CI) is an approach to merge developer working software copies into a shared mainline code on a continuous basis. CI is typically combined with automated tests, such as static analysis tests and dynamic analysis tests, to measure and profile performance of the shared mainline code.

One of the factors inhibiting the use of static analysis tools in a continuous integration (CI) development process is the fact that static analysis tool reports repeatedly show the same complaints for particular lines of source code until the complaints are resolved. These reports do not separate new complaints over duplicate, previously detected complaints. In addition, determining whether a complaint is a duplicate complaint is complicated by the fact that the underlying source code may shift positions in the repository.

### BRIEF SUMMARY

According to one embodiment of the present disclosure, an approach is provided in which a duplicate complaint detection system captures current source code partitions that each corresponds to current complaints included in a current static analysis report. The duplicate complaint detection system then computes similarity scores corresponding to the new complaints based upon aligning at least one of the current source code partitions to at least one prior source code partition corresponding to a prior complaint. The duplicate complaint detection system determines that one or more of the similarity scores are below a similarity threshold, which indicates that their corresponding current complaints are new complaints. In turn, the duplicate complaint detection system highlights the new complaints included in the current static analysis report.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment

FIG. 3 is a high-level diagram showing a duplicate complaint detection system highlighting new complaints that are included in current runs of a static analysis tool;

FIG. 4 is a high-level flowchart showing steps taken to identify new complaints in a current static analysis report by comparing information corresponding to the current complaints to information corresponding to prior complaints in a prior static analysis report;

FIG. 5 is a flowchart showing steps to generate a similarity matrix based upon ontological terms and evaluate current complaints against prior complaints;

FIG. 6 is a flowchart showing steps taken to generate similarity scores for various prior complaint/current complaint pairs corresponding to a selected ontological term;

FIG. 7 is a diagram depicting complaint entry information captured by a duplicate complaint detection system;

FIG. 8 is a diagram depicting a similarity matrix that includes similarity scores for prior complaint/current complaint pairs; and

FIG. 9 is an example of aligning a tokenized prior source code partition with a tokenized current source code partition.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

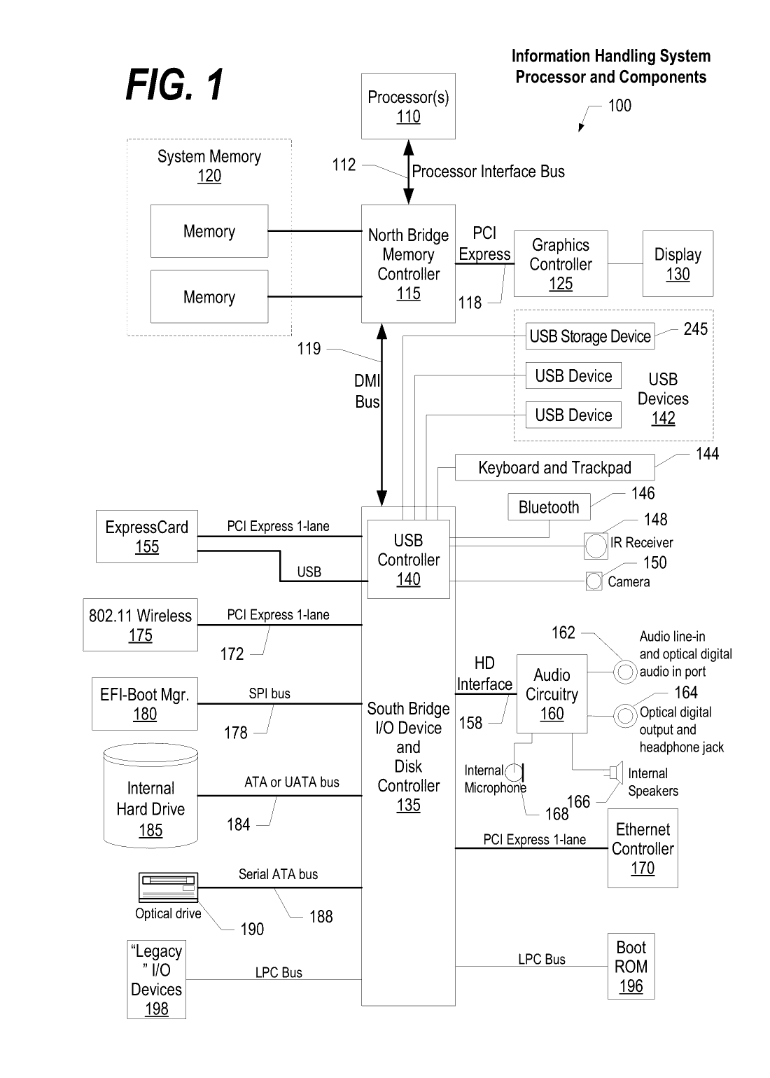

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

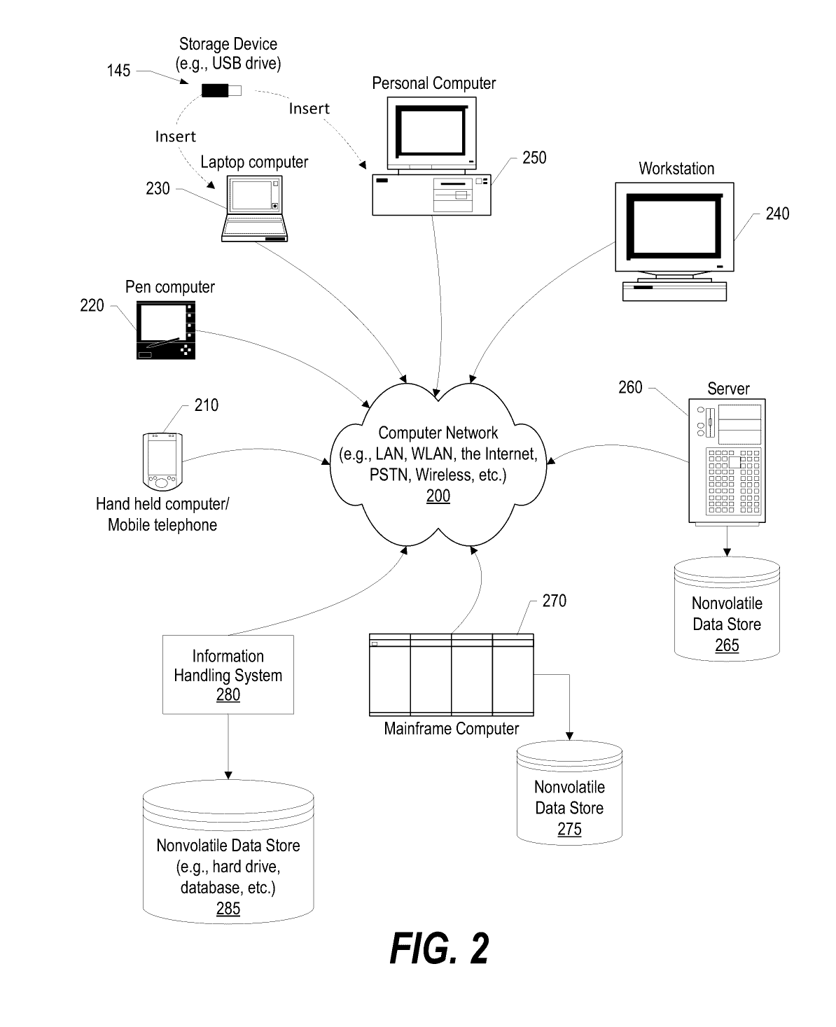

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

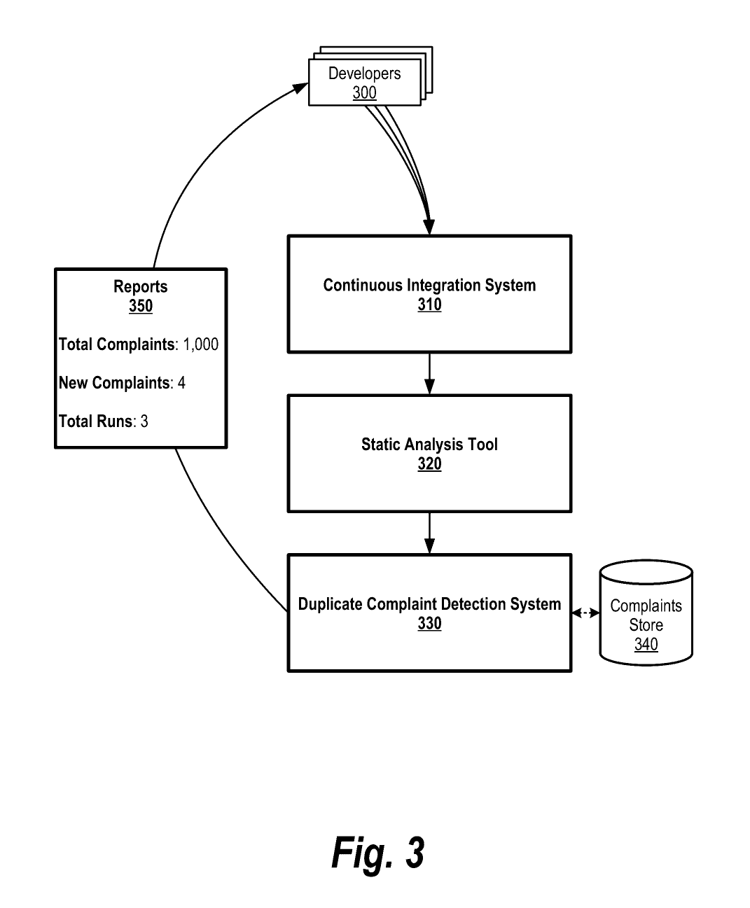

FIGS. 3 through 9 disclose an approach implemented by an information handling system. The information handling system computes similarity scores between current complaints from a current static analysis report and prior complaints from a prior static analysis report. High similarity scores indicate that a current compliant is a duplicate of a prior complaint. The information handling system identifies the current complaints that do not produce a high similarity score with any of the prior complaints and highlights those complaints as new complaints in the current static analysis report. As a result, the information handling system advances continuous integration technology by informing a developer of new complaints in a current static analysis report instead of requiring the developer to sift through all outstanding current complaints, which includes both new complaints and prior complaints.

FIG. 3 is a high-level diagram showing a duplicate complaint detection system highlighting new complaints that are included in current runs of a static analysis tool. Continuous integration system 310 receives source code changes from developers 300 on a continuing basis. At certain points in time, static analysis tool 320 analyzes the integrated source code and generates a report that includes complaints, which may also be referred to as diagnostic messages. For example, complaints may identify issues such as “write beyond bounds of array,” “missing null terminator,” etc.

The first time static analysis tool 320 generates a report for a project, duplicate complaint detection system 330 stores the complaints with sufficient detail in complaints store 340 to allow duplicate complaint detection system 330 to establish whether complaints in subsequent runs are duplicates from the prior run. For each complaint generated on the initial run, duplicate complaint detection system 330 assigns a unique identifier (UUID) and one or more ontological terms that describe the category to which the complaint is assigned (e.g. “write beyond bounds of array”). Duplicate complaint detection system 330 also captures partitions surrounding source code in proximity to each complaint, such as the previous and subsequent five lines of source code.

On following runs, duplicate complaint detection system 330 assigns ontological terms to each complaint and captures surrounding source code lines. Duplicate complaint detection system 330 then selects an ontological term and generates a similarity matrix that includes prior complaints and current complaints corresponding to the selected ontological term. For each intersecting cell of a “complaint pair” in the matrix, which includes a prior complaint and a current complaint, duplicate complaint detection system 330 tokenizes their corresponding source code and aligns the tokenized source code to compute a percent identity score between the source code surrounding the new complaints and the source code surrounding prior complaints.

In addition to the percent identity score, duplicate complaint detection system 330 computes a difference penalty score for each complaint pair, which is based upon the difference in location between the current complaint and prior complaint (e.g., source code line number, file path, etc.). In turn, duplicate complaint detection system 330 computes a similarity score for each of the complaint pairs in the similarity matrix using their corresponding percent identity score and distance penalty score.

Duplicate complaint detection system 330 then analyzes the similarity matrix and selects an intersecting cell in the matrix having the highest similarity score that exceeds a similarity threshold (0.7, for example). In turn, the intersecting cell's corresponding current complaint (in the row of the matrix) is considered to be a duplicate of the corresponding prior complaint (in the column of the matrix). The matched row and column are then removed from the similarity matrix and duplicate complaint detection system 330 continues to analyze current complaints against prior complaints until the similarity scores in all remaining intersecting cells are below the similarity threshold. At this point, only new complaints remain in the matrix because they do not correlate enough with any prior complaint. In turn, duplicate complaint detection system 330 highlights the new complaints in reports 350, such as by separating the new complaints into their own group.

In one embodiment, duplicate complaint detection system 330 may copy other properties of a prior complaint to the duplicate current complaint, such as priority or false positive indications. In this embodiment, if a defect is open in for the prior complaint, the defect number is also assigned to the corresponding current complaint to ensure that a new defect is not opened for the current complaint.

In another embodiment, because duplicate complaint detection system 330 uses ontological terms to match current complaints to prior complaints, different static analysis tools 320 may be used. For example, if a first run is performed using static analysis tool A and a follow-on run is performed using static analysis tool B, the complaints from the first run may be compared against complaints from the second run. In addition, this multiple static analysis tools may be used simultaneously without a flood of duplicate results, which is a useful feature because different static analysis tools often specialize in capturing different types of defects.

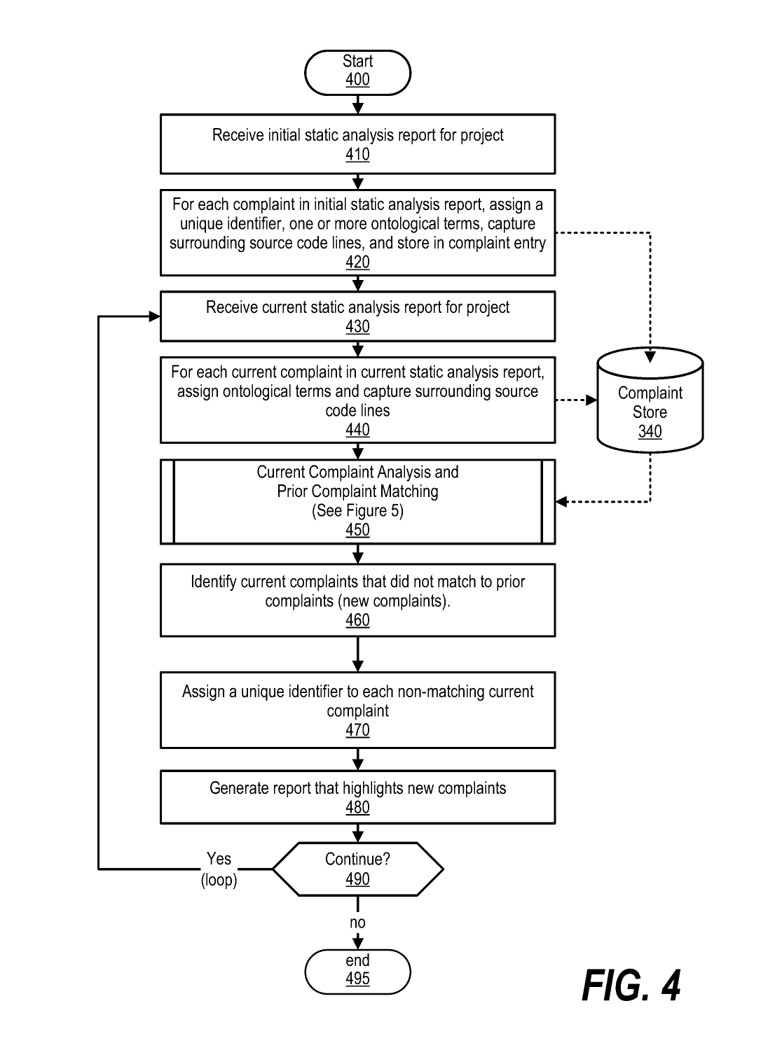

FIG. 4 is a high-level flowchart showing steps taken to identify new complaints in a current static analysis report by comparing information corresponding to the current complaints to information corresponding to prior complaints in a prior static analysis report.

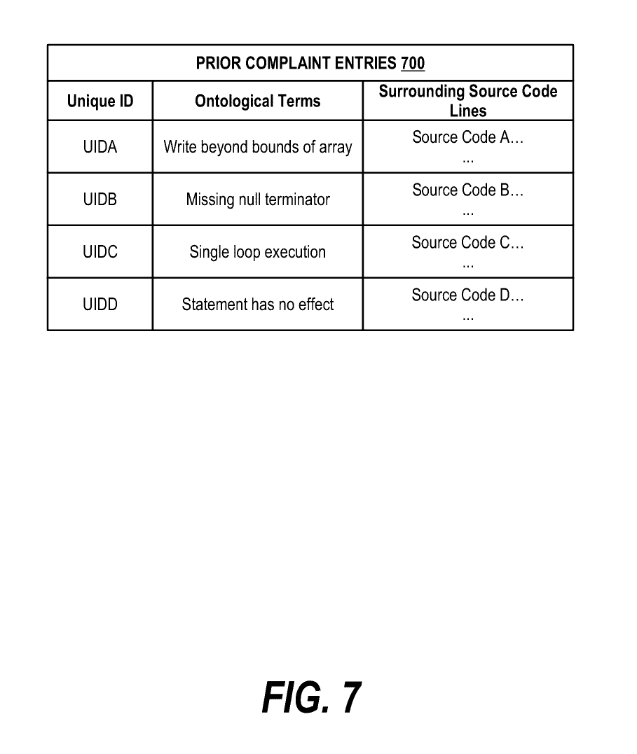

FIG. 4 processing commences at 400 whereupon, at step 410, the process receives an initial static analysis report from static analysis tool 320. At step 420, for each complaint in the initial static analysis report, the process assigns a unique identifier, one or more ontological terms, and captures source code lines surrounding the complaint (e.g. +/−five lines of code). The process also captures comments within the surrounding source code lines to compare against prior source code. The process stores the information in complaint entries in complaint store 340 (see FIG. 7 and corresponding text for further details).

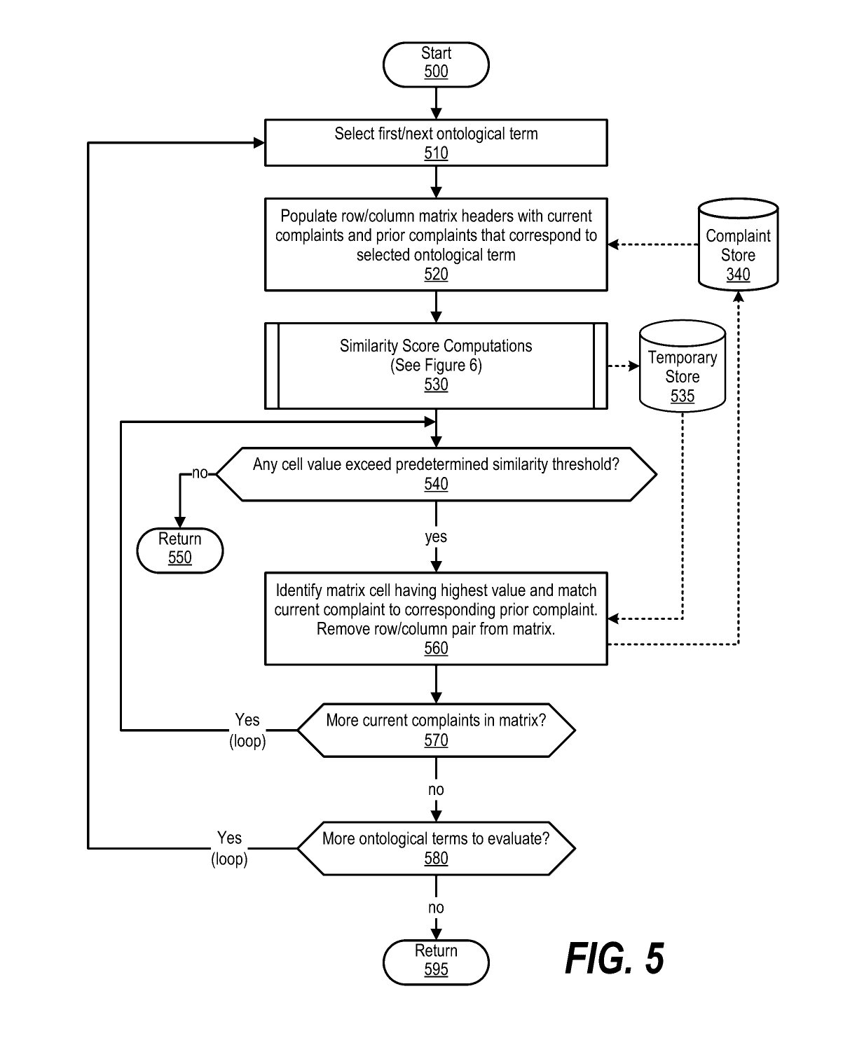

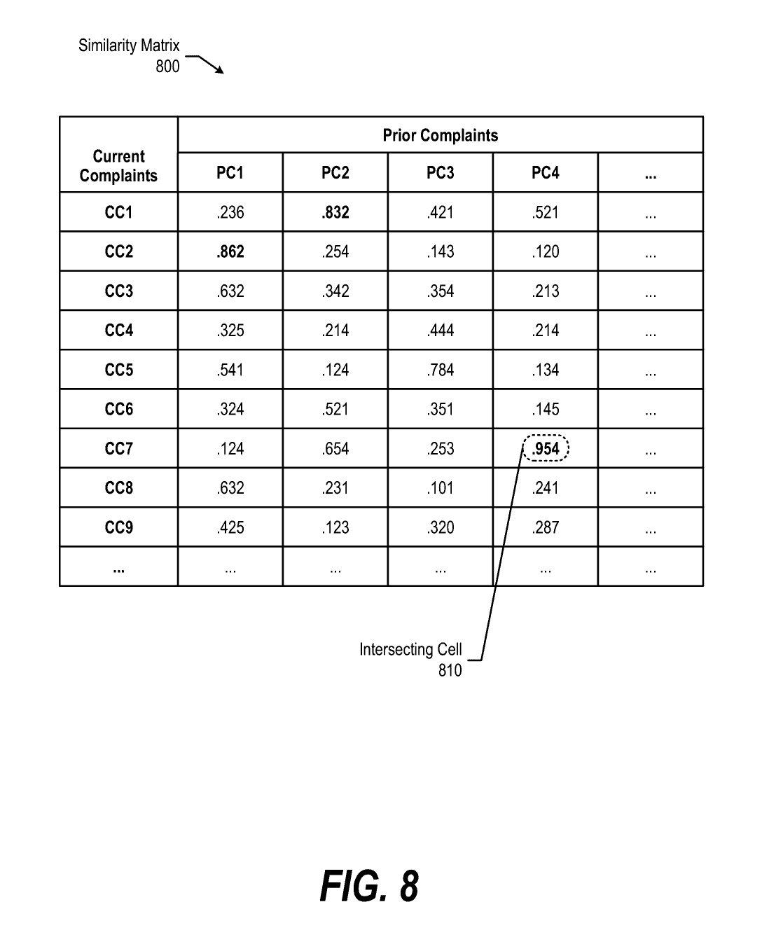

A later point in time, the process receives a current static analysis report from static analysis tool 320 (step 430). At step 440, for each current complaint in the current static analysis report, the process assigns ontological terms and captures surrounding source code lines. At predefined process 450, the process generates a similarity matrix for a selected ontological term. In one embodiment, the similarity matrix includes prior complaints in columns and current complaints in rows. In this embodiment, the process generates a similarity score for each intersecting cell in the similarity matrix and identifies current complaints that match prior complaints (see FIGS. 5, 8, and corresponding text for processing details).

At step 460, the process identifies new complaints in the current static analysis report, which are current complaints that did not match to prior complaints. At step 470, the process assigns a unique identifier to each new complaint and, at step 480, the process generates a report that highlights the new complaints.

The process determines as to whether to continue to analyze static analysis tool reports (decision 490). If the process should continue, then decision 490 branches to the ‘yes’ branch to loop back and analyze another current report. This looping continues until the process should terminate, at which point decision 490 branches to the ‘no’ branch and FIG. 4 processing thereafter ends at 495.

FIG. 5 is a flowchart showing steps to generate a similarity matrix based upon ontological terms and evaluate current complaints against prior complaints. FIG. 5 processing commences at 500 whereupon, at step 510, the process selects a first ontological term used to categorize the prior complaints and current complaints, such as “single loop execution.”

At step 520, the process populates row/column matrix headers with current complaints and prior complaints that correspond to selected ontological term. For example, FIG. 8 shows a matrix with nine current complaints and four prior complaints each corresponding to the same ontological term.

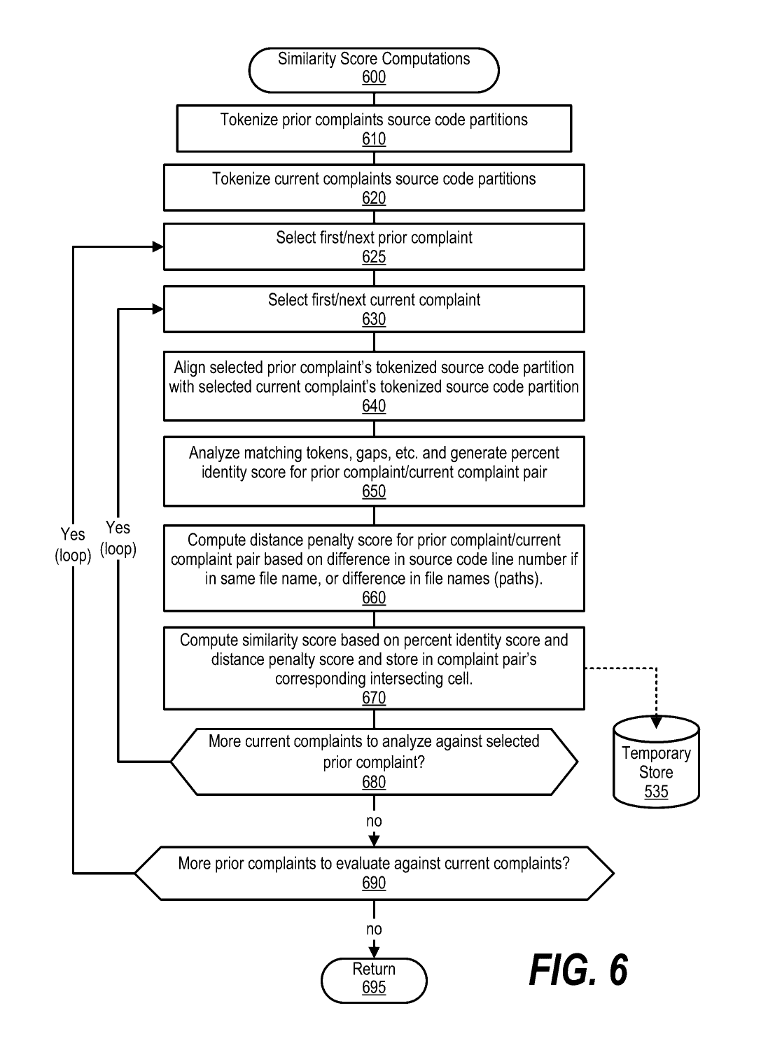

At predefined process 530, the process evaluates source code corresponding to each of the prior complaints against source code corresponding to each of the current complaints and generates similarity scores for intersecting cell corresponding to each complaint pair (prior complaint/current complaint, see FIG. 6 and corresponding text for processing details). The process determines whether any of the similarity scores exceed a similarity threshold, such as a 70% similarity (decision 540). If none of the similarity scores reach the similarity threshold, the each of the current complaints are not similar enough to a prior complaint and are considered new complaints, and decision 540 branches to the ‘no’ branch whereupon FIG. 5 processing thereafter returns to the calling routine (see FIG. 4) at 550.

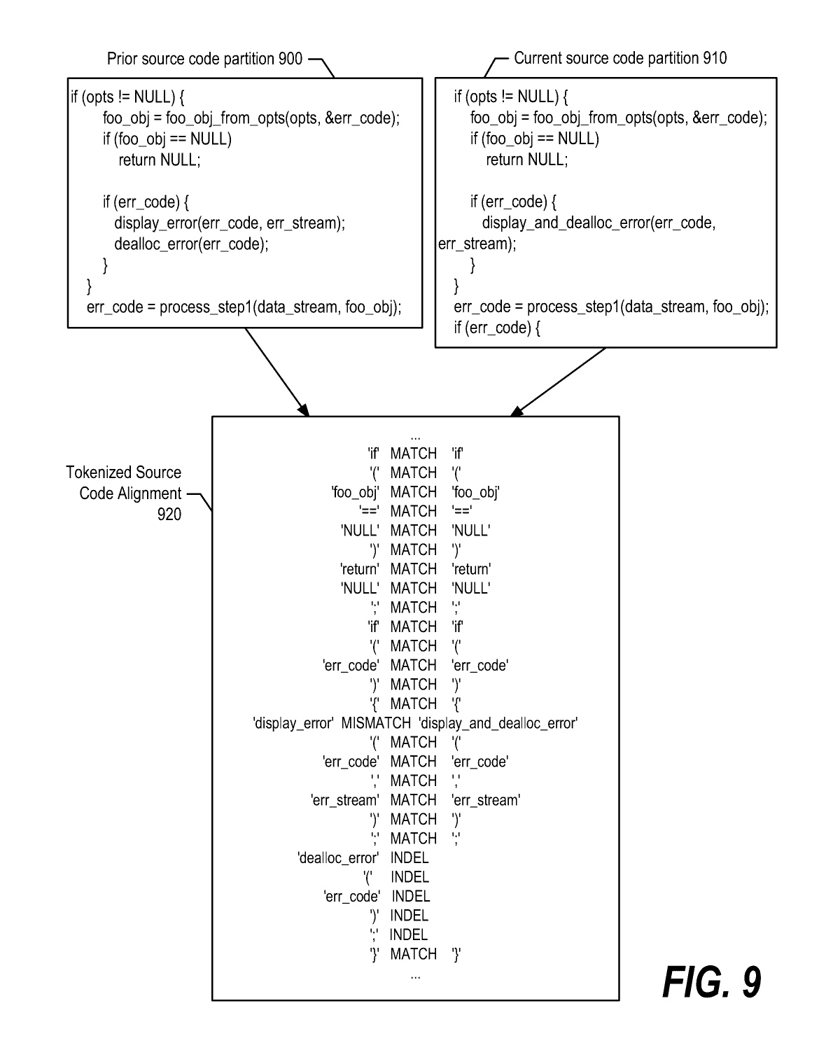

On the other hand, if at least one of the similarity scores exceed the similarity threshold, decision 540 branches to the ‘yes’ branch. At step 560, the process identifies a intersecting cell having the highest similarity score, and matches the corresponding current complaint to the corresponding prior complaint. For example, FIG. 9 shows that the intersecting cell corresponding to current complaint 7 and prior complaint 4 has a similarity score of 0.954, which is the highest score in the similarity matrix. In this example, the process removes current complaint 7 and prior complaint 4 from matrix.

The process determines as to whether there are more current complaints in the matrix (decision 570). If there are more current complaints in the matrix, then decision 570 branches to the ‘yes’ branch which loops back to determine if there are any more similarity scores that exceed the threshold. This looping continues until there are no more current complaints in the matrix, or until no similarity scores exceed the threshold as discussed above, at which point decision 570 branches to the ‘no’ branch exiting the loop.

The process determines as to whether more ontological terms to evaluate that have been assigned to one of the current complaints (decision 580). If there are more ontological terms to evaluate, then decision 580 branches to the ‘yes’ branch which loops back to select the next ontological term, generate another similarity matrix, and evaluate similarity scores in the similarity. This looping continues until there are no more ontological terms to evaluate, at which point decision 580 branches to the ‘no’ branch exiting the loop. FIG. 5 processing thereafter returns to the calling routine (see FIG. 4) at 595.

FIG. 6 is a flowchart showing steps taken to generate similarity scores for various prior complaint/current complaint pairs corresponding to a selected ontological term. Processing commences at 600 whereupon, at step 610, the process tokenizes prior source code partitions (surrounding source code lines) for each prior complaint, such as by using lexical analysis. In one embodiment, a specialized variation of tokenization does not eliminate comments, as the comments are valuable in determining similarities.

At step 620, the process tokenizes current source code partitions, which includes comments, for each current complaint. At step 625, the process selects the first prior complaint and, at step 630, the process selects the first current complaint. At step 640, the process aligns the selected prior complaint's corresponding tokenized prior source code partition with the selected current complaint's corresponding tokenized current source code partition. In one embodiment, in order to establish how similar code segment A is to code segment B, a pairwise alignment, such as a Smith-Waterman alignment, is performed on the two tokenized source code partitions. In this embodiment, the Smith-Waterman alignment is modified to include an entirety of both token sequences in the overall result, which results in mismatches or gaps at the beginning or end of the aligned sequences negatively impacting the percent identity score (see FIG. 9 and corresponding text for further details).

At step 650, the process analyzes matching tokens, gaps, etc. and generates a percent identity score for prior complaint/current complaint pair. At step 660, the process computes a distance penalty score for prior complaint/current complaint pair based on, for example, one of two factors. If the current complaint is included in the same file as the prior complaint, the process computes a distance penalty score based on the difference in source code line numbers (e.g., line 54−line 50=4 lines difference). If the current complaint is included in a different file compared with the prior complaint, the process computes a distance penalty score based on the difference in file names (e.g., c:\patha\pathb\filex versus c:\patha\filex).

At step 670, the process computes a similarity score based on the percent identity score and the distance penalty score and stores the similarity score in the complaint pair's corresponding intersecting cell (temporary store 535). For example, the process may use the formula: Similarity score=Percent identity score−distance penalty score.

The process determines as to whether there are more current complaints to analyze against the selected prior complaint (decision 680). If there are more current complaints to analyze against the selected prior complaint, then decision 680 branches to the ‘yes’ branch which loops back to select the next current complaint and compute a similarity score for the current complaint/prior complaint pair. This looping continues until there are no more current complaints to evaluate against the selected prior complaint, at which point decision 680 branches to the ‘no’ branch exiting the loop.

The process determines as to whether there are more prior complaints to evaluate against the current complaints (decision 690). If there are more prior complaints to evaluate against the current complaints, then decision 690 branches to the ‘yes’ branch, which loops back to select the next prior complaint and perform steps 630 through 680 using the next prior complaint. This looping continues until there are no more prior complaints to evaluate, at which point decision 690 branches to the ‘no’ branch exiting the loop. FIG. 6 processing thereafter returns to the calling routine (see FIG. 5) at 695.

FIG. 7 is a diagram depicting complaint entry information captured by a duplicate complaint detection system. Complaint entries 700 shows complaints that have been flagged by a static analysis tool. The complaints may have been generated on a first run or on subsequent runs. In either case, the complaints in prior complaint entries 700 are viewed as known, prior complaints when compared against current complaints from a current static analysis report.

The example in FIG. 7 shows that each complaint is issued a unique identifier, one or more ontological terms, and surrounding source code is captured and assigned to the complaint. As those skilled in the art can appreciate, more or less information may be stored with each complaint, such as whether a defect number has been assigned to the complaint.

FIG. 8 is a diagram depicting a similarity matrix that includes similarity scores for prior complaint/current complaint pairs. Similarity matrix corresponds to an ontological term and includes similarity scores in each intersecting cell. As can be seen, intersecting cell 810 includes the highest similarity score, indicating that current complaint 7 is a duplication of an already known complaint, which is prior complaint 4. As such, current complaint 7 is matched to prior complaint 4 and both row and column are removed for a subsequent analysis of similarity matrix 800.

Similarity matrix 800 shows that current complaint 2 and prior complaint 1 produce a similarity score of 0.862, which is higher than a similarity threshold of 0.7 and is the next highest similarity score. As such, current complaint 2 and prior complaint 1 will be matched on the subsequent analysis and their corresponding row/column will be removed. Likewise, current complaint 1 and prior complaint 2 produce a similarity score of 0.832 and, therefore, current complaint 1 and prior complaint 2 will be matched and their corresponding row/column will be removed.

FIG. 9 is an example of aligning a tokenized prior source code partition with a tokenized current source code partition. Prior source code partition 900 is source code that is surrounding a prior complaint, and current source code partition 910 is source code that is surrounding a current complaint. Assuming that both complaints correspond to the same ontological term, duplicate complaint detection system 330 tokenizes each source code partition and aligns the tokenized source code to produce tokenized source code alignment 920, such as by using a pairwise alignment approach. In turn, duplicate complaint detection system 330 may analyze the alignment and evaluate the number of matching tokens and the number of non-matching tokens to compute a percent identity score as discussed herein.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
capturing a plurality of current source code partitions that each corresponds to one of a plurality of current complaints included in a current static analysis report;
computing a plurality of similarity scores based upon aligning at least one of the plurality of current source code partitions to at least one of a plurality of prior source code partitions, each of the plurality of prior source code partitions corresponding to one of a plurality of prior complaints included in a prior static analysis report;
determining that one or more of the similarity scores are below a similarity threshold; and
highlighting one or more new complaints, in the plurality of current complaints, that each corresponds to the one or more similarity scores below the similarity threshold.

2. The method of claim 1 wherein, prior to the computing of the plurality of similarity scores, the method further comprises:
assigning a first ontological term to a subset of the plurality of prior complaints based upon one or more first terms included in the subset of prior complaints;
assigning a second ontological term to a subset of the plurality of current complaints based upon one or more second terms included in the subset of current complaints; and
generating a similarity matrix in response to determining that the first ontological term matches the second ontological term, wherein the similarity matrix maps each of the subset of prior complaints to each of the subset of current complaints.

3. The method of claim 2 wherein the similarity matrix comprises a plurality of intersecting cells that each correspond to one of a plurality of complaint pairs, wherein each of the plurality of complaint pairs corresponds to one of the subset of current complaints and one of the subset of prior complaints.

4. The method of claim 3 further comprising:
tokenizing each of the plurality of prior source code partitions, resulting in a plurality of tokenized prior source code partitions;
tokenizing each of the plurality of current source code partitions, resulting in a plurality of tokenized current source code partitions;
selecting one of the plurality of complaint pairs, the selected complaint pair corresponding to a selected current complaint and a selected prior complaint, wherein the aligning further comprises lining up one of the plurality of tokenized current source code partitions corresponding to the selected current complaint to one of the plurality of tokenized prior source code partitions corresponding to the selected prior complaint;
computing a percent identity score of the source code pair based upon the aligning; and
utilizing the percent identity score in the computation of the similarity score of the selected complaint pair.

5. The method of claim 4 wherein, for each of the plurality of source code pairs, the method further comprises:
analyzing a prior filename path corresponding to the selected prior complaint against a current filename path corresponding to the selected current complaint;
in response to determining that the prior filename path matches the current filename path, computing a distance penalty score based upon a prior source code line number corresponding to the selected prior complaint and a current source code line number corresponding to the selected current complaint; and
in response to determining that the prior filename path is different from the current filename path, computing the distance penalty score based upon a difference between the prior filename path and the current filename path; and
utilizing the distance penalty score in the computation of the similarity score of the complaint pair.

6. The method of claim 4 further comprising:
tokenizing at least one first comment that is included in at least one of the plurality of prior source code partitions, wherein the tokenized first comment is included in a corresponding one of the plurality of tokenized prior source code partitions; and
tokenizing at least one second comment that is included in at least one of the plurality of current source code partitions, wherein the tokenized second comment is included in a corresponding one of the plurality of tokenized current source code partitions.

7. The method of claim 1 further comprising:
for each of the plurality of similarity scores that are above the similarity threshold, identifying a corresponding current complaint and a corresponding prior complaint; and
for each of the corresponding current complaints, assigning a unique identifier of the corresponding prior complaint to the corresponding current complaint.

8. The method of claim 1 wherein each of the one or more new complaints are omitted from the plurality of prior complaints, the method further comprising:
assigning a unique identifier to each of the one or more new complaints.

9. An information handling system comprising:
one or more processors;
a memory coupled to at least one of the processors; and
a set of computer program instructions stored in the memory and executed by at least one of the processors in order to perform actions of:
capturing a plurality of current source code partitions that each corresponds to one of a plurality of current complaints included in a current static analysis report;
computing a plurality of similarity scores based upon aligning at least one of the plurality of current source code partitions to at least one of a plurality of prior source code partitions, each of the plurality of prior source code partitions corresponding to one of a plurality of prior complaints included in a prior static analysis report;
determining that one or more of the similarity scores are below a similarity threshold; and
highlighting one or more new complaints, in the plurality of current complaints, that each corresponds to the one or more similarity scores below the similarity threshold.

10. The information handling system of claim 9 wherein, prior to the computing of the plurality of similarity scores, at least one of the one or more processors perform additional actions comprising:
assigning a first ontological term to a subset of the plurality of prior complaints based upon one or more first terms included in the subset of prior complaints;
assigning a second ontological term to a subset of the plurality of current complaints based upon one or more second terms included in the subset of current complaints; and
generating a similarity matrix in response to determining that the first ontological term matches the second ontological term, wherein the similarity matrix maps each of the subset of prior complaints to each of the subset of current complaints.

11. The information handling system of claim 10 wherein the similarity matrix comprises a plurality of intersecting cells that each correspond to one of a plurality of complaint pairs, wherein each of the plurality of complaint pairs corresponds to one of the subset of current complaints and one of the subset of prior complaints.

12. The information handling system of claim 11 wherein at least one of the one or more processors perform additional actions comprising:
tokenizing each of the plurality of prior source code partitions, resulting in a plurality of tokenized prior source code partitions;
tokenizing each of the plurality of current source code partitions, resulting in a plurality of tokenized current source code partitions;
selecting one of the plurality of complaint pairs, the selected complaint pair corresponding to a selected current complaint and a selected prior complaint, wherein the aligning further comprises lining up one of the plurality of tokenized current source code partitions corresponding to the selected current complaint to one of the plurality of tokenized prior source code partitions corresponding to the selected prior complaint;
computing a percent identity score of the source code pair based upon the aligning; and
utilizing the percent identity score in the computation of the similarity score of the selected complaint pair.

13. The information handling system of claim 12 wherein, for each of the plurality of source code pairs, at least one of the one or more processors perform additional actions comprising:
analyzing a prior filename path corresponding to the selected prior complaint against a current filename path corresponding to the selected current complaint;
in response to determining that the prior filename path matches the current filename path, computing a distance penalty score based upon a prior source code line number corresponding to the selected prior complaint and a current source code line number corresponding to the selected current complaint; and
in response to determining that the prior filename path is different from the current filename path, computing the distance penalty score based upon a difference between the prior filename path and the current filename path; and
utilizing the distance penalty score in the computation of the similarity score of the complaint pair.

14. The information handling system of claim 12 wherein at least one of the one or more processors perform additional actions comprising:
tokenizing at least one first comment that is included in at least one of the plurality of prior source code partitions, wherein the tokenized first comment is included in a corresponding one of the plurality of tokenized prior source code partitions; and
tokenizing at least one second comment that is included in at least one of the plurality of current source code partitions, wherein the tokenized second comment is included in a corresponding one of the plurality of tokenized current source code partitions.

15. The information handling system of claim 9 wherein at least one of the one or more processors perform additional actions comprising:
for each of the plurality of similarity scores that are above the similarity threshold, identifying a corresponding current complaint and a corresponding prior complaint; and
for each of the corresponding current complaints, assigning a unique identifier of the corresponding prior complaint to the corresponding current complaint.

16. A computer program product stored in a computer readable storage medium, comprising computer program code that, when executed by an information handling system, causes the information handling system to perform actions comprising:
capturing a plurality of current source code partitions that each corresponds to one of a plurality of current complaints included in a current static analysis report;
computing a plurality of similarity scores based upon aligning at least one of the plurality of current source code partitions to at least one of a plurality of prior source code partitions, each of the plurality of prior source code partitions corresponding to one of a plurality of prior complaints included in a prior static analysis report;
determining that one or more of the similarity scores are below a similarity threshold; and
highlighting one or more new complaints, in the plurality of current complaints, that each corresponds to the one or more similarity scores below the similarity threshold.

17. The computer program product of claim 16 wherein, prior to the computing of the plurality of similarity scores, the information handling system performs additional actions comprising:
assigning a first ontological term to a subset of the plurality of prior complaints based upon one or more first terms included in the subset of prior complaints;
assigning a second ontological term to a subset of the plurality of current complaints based upon one or more second terms included in the subset of current complaints; and
generating a similarity matrix in response to determining that the first ontological term matches the second ontological term, wherein the similarity matrix maps each of the subset of prior complaints to each of the subset of current complaints.

18. The computer program product of claim 17 wherein the similarity matrix comprises a plurality of intersecting cells that each correspond to one of a plurality of complaint pairs, wherein each of the plurality of complaint pairs corresponds to one of the subset of current complaints and one of the subset of prior complaints.

19. The computer program product of claim 18 wherein the information handling system performs additional actions comprising:
tokenizing each of the plurality of prior source code partitions, resulting in a plurality of tokenized prior source code partitions;
tokenizing each of the plurality of current source code partitions, resulting in a plurality of tokenized current source code partitions;
selecting one of the plurality of complaint pairs, the selected complaint pair corresponding to a selected current complaint and a selected prior complaint, wherein the aligning further comprises lining up one of the plurality of tokenized current source code partitions corresponding to the selected current complaint to one of the plurality of tokenized prior source code partitions corresponding to the selected prior complaint;
computing a percent identity score of the source code pair based upon the aligning; and
utilizing the percent identity score in the computation of the similarity score of the selected complaint pair.

20. The computer program product of claim 19 wherein, for each of the plurality of source code pairs, the information handling system performs additional actions comprising:
analyzing a prior filename path corresponding to the selected prior complaint against a current filename path corresponding to the selected current complaint;
in response to determining that the prior filename path matches the current filename path, computing a distance penalty score based upon a prior source code line number corresponding to the selected prior complaint and a current source code line number corresponding to the selected current complaint; and
in response to determining that the prior filename path is different from the current filename path, computing the distance penalty score based upon a difference between the prior filename path and the current filename path; and
utilizing the distance penalty score in the computation of the similarity score of the complaint pair.
